(19) United States
(12) Patent Application Publication
(10) Pub. No.: US 2013/0247611 A1
(43) Pub. Date: Sep. 26, 2013

(54) METHOD AND APPARATUS FOR SEPARATING AIR BY CRYOGENIC DISTILLATION

(71) Applicant: Golo Zick, Houston, TX (US)

(72) Inventor: Golo Zick, Houston, TX (US)

(21) Appl. No.: 13/695,162

(22) PCT Filed: Mar. 25, 2011
(86) PCT No.: PCT/FR2011/050647

§ 371 Date: Oct. 29, 2012

(30) Foreign Application Priority Data
May 10, 2010 (FR) 10 53616

(51) Int. Cl. F25J 3/08; B01D 3/00

(52) U.S. Cl. CPC F25J 3/08; B01D 3/00
USPC 62/643; 202/162

(57) ABSTRACT

A method and apparatus for the cryogenic distillation of air to produce gaseous oxygen with a purity between 75 and 95 mol % and a pressure lower than 5.5 bar abs using a triple column having a high-pressure column, a low-pressure column, and a medium-pressure column, wherein the medium-pressure column is at least partially thermally coupled with the low-pressure column and the high-pressure column is also at least partially thermally coupled with the low-pressure column.

### CROSS REFERENCE TO RELATED APPLICATIONS

This application is a §371 of International PCT Application PCT/FR2011/050647 filed Mar. 25, 2011, which claims priority to France Patent Application no. 1053616, filed May 10, 2010, the entire contents of which are incorporated herein by reference.

### TECHNICAL FIELD OF THE INVENTION

The present invention relates to a process and apparatus for separating air by cryogenic distillation. More specifically, the present invention is focused on producing low pressure oxygen.

### BACKGROUND

With the objective of preventing the emission of CO₂ into the atmosphere, oxy-fuel combustion cycles are of increasing interest. The size of the air separation units for combustion with oxygen instead of air must be much larger than the existing ones. So as not to excessively degrade the overall efficiency of the power station/air separation unit assembly, oxygen with a very low specific cost is sought, while keeping investment costs as low as possible. There is practically no need for a production of nitrogen.

In a triple column, the top of the high-pressure column may be thermally connected with the bottom of the low-pressure column and the bottom of the medium-pressure column. Alternatively, the bottom of the low-pressure column is thermally connected with the top of the medium-pressure column and the bottom of the medium-pressure column with the top of the high-pressure column. In the latter case, a dephlegmator placed in the bottom of the medium-pressure column and/or the bottom of the low-pressure column may provide the thermal link. If the dephlegmator is in the bottom of one of these columns, the thermal link for the bottom of the other may be provided by one or more reboilers.

It is known to thermally connect a medium-pressure column to a low-pressure column by means of a dephlegmator in JP-A-2006349319 and FR-A-2945111.

A typical temperature diagram according to FR-A-2945111 is shown in FIG. 1. The large temperature differences are easily seen therein at the ends of the columns due to the minimal temperature difference at the pinch plate which imposes the pressure in the medium-pressure column. However, the temperature difference, which is a main entropy creation source, prevents the separation energy from being reduced. The diagram from FR-A-2945111 has a separation energy of around 0.276 kWh/Nm³ for a purity of 95 mol % oxygen. This number is obtained with a refrigeration unit in the exchange line. The pressure at the top of the medium-pressure column is only around 33 bar.

### SUMMARY OF THE INVENTION

One objective of the invention is to produce oxygen at very low pressure (between 1.2 and 2 bar_{abs}, for example with 1.7 bar_{abs}) and at low purity (75 to 95 mol %, preferably between 85 and 95 mol %) with a very low separation energy, while respecting the constraints of very high flow rates.

According to one subject of the invention, provision is made for a process for the cryogenic distillation of air for producing gaseous oxygen having a purity of between 75 and 95 mol %, preferably between 85 and 95 mol % and a pressure of less than 5 bar abs, preferably of less than 2.5 bar abs,
i) with a triple column comprising an auxiliary column, a medium-pressure column and a low-pressure column
ii) the medium-pressure column being completely or partly thermally coupled to the low-pressure column by means of a first dephlegmator,
iii) air being sent to the medium-pressure column,
iv) a bottoms liquid being sent from the auxiliary column to the top of the low-pressure column and optionally to the top of the medium-pressure column,
v) an overhead gas being sent from the medium-pressure column to the bottom of the auxiliary column,
vi) a bottoms liquid from the medium-pressure column being sent to the top of the low-pressure column,
vii) a gas being withdrawn at the top of the low-pressure column,
viii) a fluid containing between 75 and 95 mol % of oxygen is withdrawn as bottoms from the low-pressure column,
ix) the auxiliary column being partly thermally coupled with the low-pressure column by means of an exchanger,
   characterized in that the auxiliary column is a high-pressure column, the overhead gas is sent from the medium-pressure column to the bottom. of the high-pressure column via a compressor, the medium-pressure column being completely or partly thermally coupled to the middle of the low-pressure column by means of the first dephlegmator and the high-pressure column is completely or partly thermally coupled with the bottom of the low-pressure column by means of a second dephlegmator.

In other embodiments:
the first dephlegmator exchanges heat with a region of the low-pressure column above that with which the second dephlegmator exchanges heat;
the overhead gas from the medium-pressure column being at least partly compressed in a cold supercharger before being sent to the high-pressure column;
the cold-compressed gas constitutes the only feed of the high-pressure column;
the high-pressure column operates at total reflux;
bottoms liquid from the medium-pressure column is sent to the top of the high-pressure column and/or to the middle, preferably above the thermal coupling zone, of the low-pressure column.

According to another subject of the invention, provision is made for a diabatic distillation unit comprising an auxiliary column (high-pressure column), a medium-pressure column and a low-pressure column, a first dephlegmator ensuring heat exchange between the low-pressure column and the high-pressure column, a second dephlegmator ensuring heat exchange between the medium-pressure column and the low-pressure column, an air line feeding the medium-pressure column, a line connecting the top of the medium-pressure column and the bottom of the high-pressure column, no reheating means being connected between the medium-pressure column and the compressor, a line for sending a bottoms liquid from the high-pressure column to the top of the low-pressure column and optionally to the top of the medium-pressure column, a line for sending a bottoms liquid from the medium-pressure column to an intermediate region of the low-pressure column, a line for withdrawing an overhead gas from the low-pressure column and a line for withdrawing a bottoms liquid from the low-pressure column, characterized in that the auxiliary column is a high-pressure column, a compressor connects the top of the medium-pressure column and the bottom of the high-pressure column, the first dephlegmator ensures heat exchange between the bottom of the low-pressure column and the high-pressure column and the second dephlegmator ensures heat exchange between the medium-pressure column and an upper region of the low-pressure column.

A pump may be connected to the bottom of the low-pressure column in order to raise the pressure of the oxygen-rich product to its evaporating pressure. In this case, the oxygen is vaporized outside of a main exchange line.

The process according to one embodiment of the invention uses a unit containing three distillation columns, with dephlegmators between the high-, medium- and low-pressure columns. Liquid oxygen is withdrawn at the bottom of the low-pressure column in order to avoid the evaporation to dryness thereof and this liquid is convened to vapor in an external reboiler with air as hot fluid. The objective is to reduce the average temperature difference between the columns. In order to do this, it is proposed to divide the MP column into two sections, one with a lower pressure (MP′ column) thermally coupled to the middle of the LP column and one with a slightly higher pressure (HP′ column) which is thermally coupled to the bottom of the LP column. The principle is shown in FIG. 2 and the relationship between temperature and the position in the columns in FIG. 3. Since there is, unlike diabatic distillation with two columns, only one portion of the feed of the MP′ column compressed to the pressure of the HP′ column, a total compression energy saving will be obtained.

### BRIEF DESCRIPTION OF THE FIGURES

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 represents a typical temperature diagram.

FIG. 2 represents a unit operating in accordance with an embodiment of the invention.

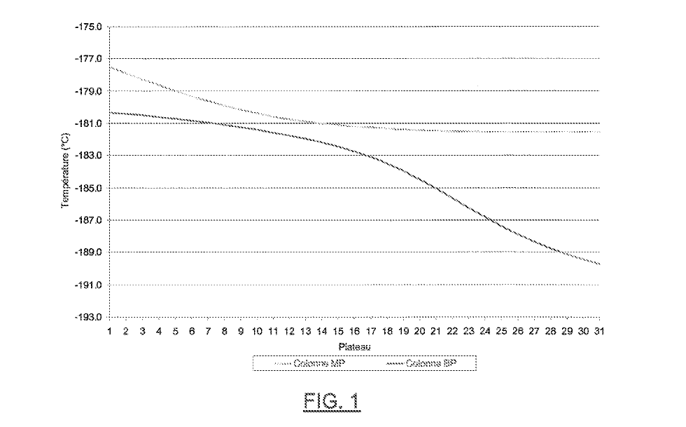

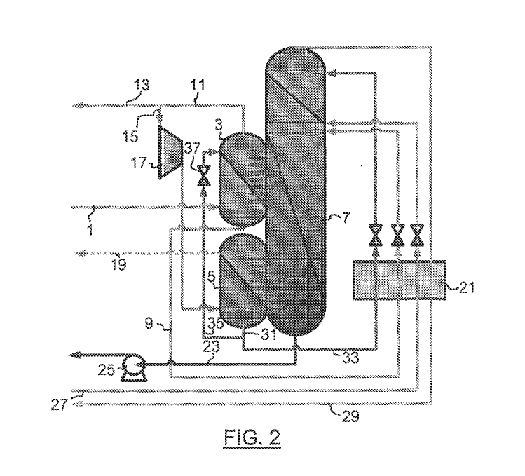

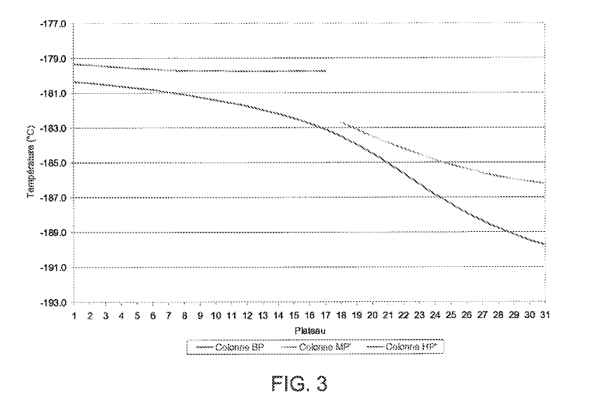

### DETAILED DESCRIPTION

A stream of gaseous air 1 having a pressure of less than 3.9 bar is sent to the bottom of the MP′ column 3. The MP′ column 3 is thermally coupled with the middle of the LP column (working at pressures of less than 1.8 bar_{abs}) by means of a dephlegmator. An oxygen-enriched liquid stream 9 is withdrawn at the bottom of the MP′ column 3 and sent to a higher level. of the LP column 7 after expansion in a valve and cooling in the exchanger 21.

A nitrogen-enriched gaseous stream 11 is withdrawn from the top of the MP′ column 3 and divided into two. One portion 13 is used as product or is vented and the remainder 15 is compressed in a cold compressor 17 without having been reheated and sent to the bottom of the HP′ column 5 which operates at a pressure above that of the MP′ column 3 but below 5.5 bar_{abs}. The HP′ column 5 is thermally linked with the lower section of the LP column by means of a dephlegmator. Since nitrogen 15 is the only stream feeding the HP′ column 5, it is separated therein in order to optionally form a phase 19 very rich in nitrogen at the top of the column which may be utilized as product and a bottoms stream 31 that is as rich or richer in oxygen than the stream 15. The liquid bottoms stream 31 may be divided into two, one portion 35 being expanded and sent to the top of the MP′ column 3 as reflux reinforcement (not imperative) and the other portion 33 being expanded and sent to the top of the LP column 7 (in all cases).

A stream of partially or completely liquefied air 27 is sent to the LP column 7 at the same level or higher than the liquid 9 originating from the MP′ column 3, both of which are lower than the delivery level of the liquid 33.

A gaseous stream 29 containing low-pressure nitrogen is withdrawn at the top of the LP column 7 and a liquid stream 23 is withdrawn at the bottom of the LP column 7, pressurized by a pump 25 and optionally vaporized against air in a dedicated reboiler (not shown) or in the exchange line. The stream 23 is at a pressure of between 1.2 and 2 bar_{abs}, downstream of the pump 25 and at low purity containing between 75 and 95 mol % of oxygen, preferably between 85 and 95 mol % of oxygen.

By lowering the purity of the oxygen, the separation energy (i.e., energy required for the separation) will significantly decrease.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1-11. (canceled)

12. A process for the cryogenic distillation of air for producing gaseous oxygen having a purity of between 75 and 95 mol %, and a pressure of less than 5 bar abs, the process comprising the steps of
i) providing a triple column comprising an auxiliary column, a medium-pressure column, and a low-pressure column, wherein the auxiliary column is a high-pressure column, wherein the medium-pressure column is at least partially thermally coupled to the low-pressure column using a first dephlegmator, wherein the auxiliary column is at least partially thermally coupled to the low-pressure column using a second dephlegmator, wherein the auxiliary column is a high-pressure column;
ii) introducing air to the medium-pressure column;
iii) sending a bottoms liquid from the auxiliary column to the top of the low-pressure column;
iv) sending an overhead gas from the medium-pressure column to the bottom of the auxiliary column using a compressor;
v) sending a bottoms liquid from the medium-pressure column to the low-pressure column,
vi) withdrawing a gas at the top of the low-pressure column; and
vii) withdrawing a fluid containing between 75 and 95 mol % of oxygen as bottoms from the low-pressure column.

13. The process as claimed in claim 12, wherein the first dephlegmator exchanges heat with a region of the low-pressure column above that with which the second dephlegmator exchanges heat.

14. The process as claimed in claim 12, wherein the overhead gas from the medium-pressure column being at least partly compressed in a cold supercharger before being sent to the high-pressure column.

15. The process as claimed in claim 14, wherein the gas compressed by the cold supercharger constitutes the only feed of the high-pressure column.

16. The process as claimed in claim 12, wherein the overhead gas from the medium-pressure column constitutes the only feed of the high-pressure column.

17. The process as claimed in claim 12, wherein the high-pressure column operates at total reflux.

18. The process as claimed in claim 12, Wherein the medium-pressure column is partially thermally coupled to the low-pressure column using a first dephlegmator.

19. The process as claimed in claim 12, wherein the auxiliary column is partially thermally coupled to the low-pressure column using a heat exchanger.

20. The process as claimed in claim 12, wherein the step of sending a bottoms liquid from the auxiliary column to the top of the low-pressure column further comprises the step of sending a portion of the bottoms liquid from the auxiliary column to the top of the medium-pressure column.

21. The process as claimed in claim 12, wherein a portion of the bottoms liquid from the medium-pressure column is sent to the top of the high-pressure column.

22. The process as claimed in claim 12, wherein a portion of the bottoms liquid from the medium-pressure column is introduced to the low-pressure column at a point above the first dephlegmator.

23. The process as claimed in claim 12, wherein the medium-pressure column and the high-pressure column have an absence of direct thermal integration, such that the high-pressure column and the medium-pressure column do not directly exchange heat.

24. A diabatic distillation unit comprising:
a high-pressure column;
a medium-pressure column; and
a low-pressure column;
a first dephlegmator configured to provide heat exchange between a lower region of the low-pressure column and the high-pressure column;
a second dephlegmator configured to provide heat exchange between the medium pressure column and an upper region of the low-pressure column;
an air line configured to feed the medium-pressure column;
a first line connecting the top of the medium-pressure column and the bottom of the high-pressure column;
a compressor connected to the top of the medium-pressure column and the bottom of the high-pressure column;
an absence of reheating means being connected between the medium-pressure column and the compressor;
a second line configured to send a bottoms liquid from the high-pressure column to the top of the low-pressure column;
a third line configured to send a bottoms liquid from the medium-pressure column to an intermediate region of the low-pressure column;
a fourth line configured to withdraw an overhead gas from the low-pressure column; and
a fifth line configured to withdraw a bottoms liquid from the low-pressure column,

25. The unit as claimed in claim 24 further comprising a pump connected to the bottom of the low-pressure column, the pump configured to withdraw fluid from the bottom of the low-pressure column.

26. The unit as claimed in claim 24 further comprising a line for sending a portion of the bottoms liquid from the high-pressure column to the top of the medium pressure column.

27. The unit as claimed in claim 24 further comprising an absence of means for feeding the high-pressure column with air.

28. The unit as claimed in claim 24, comprising a sixth line configured to withdraw a nitrogen-rich gas from the top of the high-pressure column.

29. The unit as claimed in claim 24, wherein the low-pressure column, the medium-pressure column and the high-pressure column are all distillation columns.

30. The unit as claimed in claim 24, wherein the low-pressure column operates between 1.2 and 2 bar abs, wherein the medium-pressure column operates between 3.7 and 3.9 bar abs, and the high-pressure column operates at a pressure above the medium-pressure column and below 5.5 bar abs.

31. The unit as claimed in claim 24, further comprising an absence of direct heat exchange means between the high-pressure column and the medium-pressure column.
